(19) United States
(12) Patent Application Publication
(10) Pub. No.: US 2021/0097133 A1
(43) Pub. Date: Apr. 1, 2021

(54) PERSONALIZED PROACTIVE PANE POP-UP

(71) Applicant: Microsoft Technology Licensing, LLC, Redmond, WA (US)

(72) Inventors: Huakai Liao, Vancouver (CA); Debapriya Pal, Sunnyvale, CA (US); Sun Mao, Bellevue, WA (US); Erik Thomas Oveson, Renton, WA (US); Huitian Jiao, Redmond, WA (US); Daniel M Cheung, San Francisco, CA (US); Derek Martin Johnson, Sunnyvale, CA (US); Bogdan Popp, Kirkland, WA (US)

(21) Appl. No.: 16/585,441

(22) Filed: Sep. 27, 2019

(51) Int. Cl. G06F 17/21; G06K 9/62; G06N 20/00; G06F 11/34; G06F 17/24

(52) U.S. Cl. CPC G06F 17/211; G06K 9/6256; G06F 17/24; G06F 11/3438; G06N 20/00

(57) ABSTRACT

A system and method for personalizing a display of a recommendation in a user interface element of an application is described. The system accesses application activities of a user of the application. A user preference is formed based on the application activities. The system identifies a context of a current activity of the application and generates a content recommendation in the application based on the context of the current activity of the application and the user preference.

### BACKGROUND

The subject matter disclosed herein generally relates to a special-purpose machine that learn user application activities and personalize user interface elements, including computerized variants of such special-purpose machines and improvements to such variants. Specifically, the present disclosure addresses systems and methods for generating and displaying personalized pane pop-ups of an application.

A content creation application (such as presentation authoring tool) may provide content suggestions to a user of the content creation application. However, the display of the suggestions may disrupt the user's attention and interrupt the user's flow of content creation activity.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 illustrates an example of enterprise application in accordance with one embodiment.

FIG. 3 is a block diagram illustrating a pane personalization engine in accordance with one example embodiment.

FIG. 4 illustrates a personalization module in accordance with one embodiment.

FIG. 5 is a flow diagram illustrating a method for training a machine learning model in accordance with one example embodiment.

FIG. 6 is a flow diagram illustrating a method for displaying a user interface notification element in accordance with one example embodiment.

FIG. 7 is a flow diagram illustrating a method for preventing the application from displaying a suggested content in accordance with one example embodiment.

FIG. 8 is a flow diagram illustrating a method for determining an individual context pattern in accordance with one example embodiment.

FIG. 9 is a flow diagram illustrating a method for identifying a user cohort in accordance with one example embodiment.

FIG. 10 is a flow diagram illustrating a routine in accordance with one embodiment.

FIG. 11 illustrates an example of a graphical user interface in accordance with one example embodiment.

FIG. 12 illustrates an example of a graphical user interface in accordance with one example embodiment.

FIG. 13 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

An enterprise represents an organization or groups of users associated with an organization. The users of the enterprise may make use of enterprise applications operating on client machines. Examples of enterprise applications include chat-based applications, email applications, document editing applications, document sharing applications, and other types of applications used by enterprises.

The present application describes a system for determining whether to display a personalized user interface element (e.g., personalized proactive pane pop-up) in an enterprise application operated by the user by learning the user's behavior and based on the user's cohort. For example, Microsoft PowerPoint Designer™ proactively triggers a pane pop-up that provides content suggestion (also referred to as content recommendation) to the user. However, blindly popping-up the pane could disrupt the user's attention and can result in a negative user experience. The present application describes a personalized proactive triggering mechanism that implicitly learns user preference and determines whether to display the pane in the application. In one example embodiment, the system for the pop-up pane trigger mechanism is based on the following parameters: a frequency of whether the user has chosen the suggestion offered in the past; the kind of content already present in the user document; the quality of suggestion offered in the pane prompt (as determined by the user); the types of actions the user was taking prior to the pane prompt (to determine whether the user is deeply focused on operating the application—this also referred to as “focused mode” or “focus mode”); and the user's frequency of engagement with the product (e.g., how often they interact with the application).

The system trains a machine learning model based on the above parameters. The machine learning model can then be used to determine whether to generate and display a pane pop-up in the application. In an alternative embodiment, for users who have not been interacting with the product regularly (or who do not have a long history of engaging with the product), the system infers whether the user would like to use the suggestion feature by considering habits of similar cohorts. For example, the system determines the cohort of the user based on the following parameters: an enterprise segment of the user (e.g., major enterprise, small and medium enterprise, EDU, consumer); top collaborators the user has interacted with;—groups to which the user belong; a manner in which the product is introduced to the user (e.g., first-time user, renewal); operating system and endpoint the user uses; and the time of the day the user uses the product.

The present system leverages the above parameters to determine user behavior pattern and categorize the user into a corresponding cohort based on the above parameters. The system then uses the corresponding cohort to infer user preference. In one example embodiment, the present application describes a system and method for personalizing a display of a recommendation in a user interface element of an application. The system accesses application activities of a user of the application. A user preference is formed based on the application activities. The system identifies a context of a current activity of the application and generates a content recommendation in the application based on the context of the current activity of the application and the user preference.

As a result, one or more of the methodologies described herein facilitate solving the technical problem of providing (or preventing an application from) relevant information that a user may not be aware. As such, one or more of the methodologies described herein may obviate a need for certain efforts or computing resources. Examples of such computing resources include processor cycles, network traffic, memory usage, data storage capacity, power consumption, network bandwidth, and cooling capacity.

The present application describes a system that monitors a user profile and user application activities based on the privacy settings configured by the user. For example, the user may specify that the system is allowed to access certain data (e.g., location data, web tracking, etc.) at certain times (e.g., during working hours) or at certain geographic locations (e.g., at work only). In another example, the user may be provided with different privacy sharing level options. The system accesses the user data based on the privacy level option selected and authorized by the user.

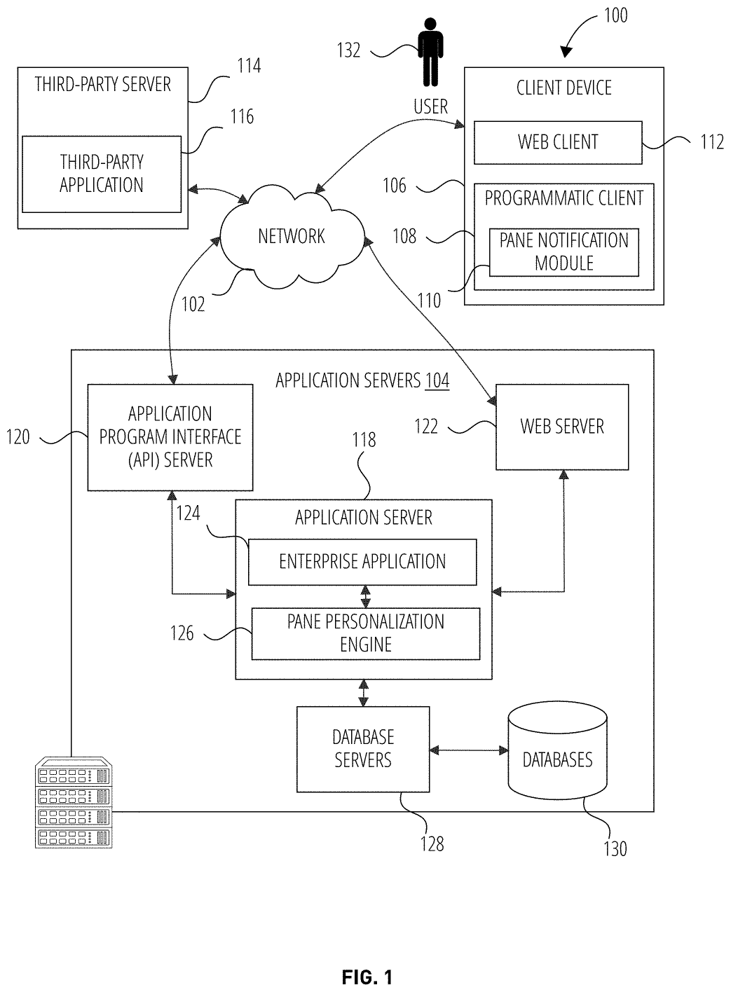

FIG. 1 is a diagrammatic representation of a network environment in which some example embodiments of the present disclosure may be implemented or deployed. One or more application servers 104 provide server-side functionality via a network 102 to a networked user device, in the form of a client device 106. A user 132 operates the client device 106. The client device 106 includes a web client 112 (e.g., a browser operating a web version of an enterprise application), a programmatic client 108 (e.g., a client-side enterprise application such as Microsoft PowerPoint™) that is hosted and executed on the client device 106. In one example embodiment, the programmatic client 108 includes a pane notification module 110 that triggers a display of a user interface element (e.g., pane pop-up) of a recommended or suggested content in the graphical user interface of the programmatic client 108. The recommended or suggested content may include a suggested format of a content provided by the user 132 in the programmatic client 108. For example, the pane notification module 110 determines a suggested format of the content and presents the suggested format using the graphical user interface of the programmatic client 108 to trigger a pane pop-up that includes the suggested format of the content. In another example embodiment, the pane notification module 110 learns from the user's behaviors (with respect to the programmatic client 108) and determines whether to trigger the pane pop-up at the programmatic client 108.

The pane notification module 110 may operate with the web client 112 and/or the programmatic client 108. In another example embodiment, the pane notification module 110 is part of the programmatic client 108 or web client 112. For example, the pane notification module 110 may operate as an extension or add on to the web client 112.

An Application Program Interface (API) server 120 and a web server 122 provide respective programmatic and web interfaces to application servers 104. A specific application server 118 hosts an enterprise application 124 and a pane personalization engine 126. Both enterprise application 124 and pane personalization engine 126 include components, modules and/or applications. In another example embodiment, the application server 118 hosts other applications in addition to the enterprise application 124. For example, other hosted applications are not necessarily enterprise-related (e.g., music application, drawing application). In other words, the present system (e.g., pane personalization engine 126) can also be applied to non-enterprise applications.

The enterprise application 124 may include a content creation application (e.g., Microsoft PowerPoint™) that enables the user 132 to form content slides for presentation. The enterprise application 124 also includes a collaborative application that enables peer enterprise users to collaborate on a shared document. For example, the client device 106 may access the enterprise application 124 to view and edit a document that is shared with other peer users. Other examples of enterprise application 124 includes enterprise systems, content management systems, and knowledge management systems. The enterprise application 124 communicates with the programmatic client 108 on the client device 106. For example, the programmatic client 108 checks in with the enterprise application 124 to verify a validity of a license of the programmatic client 108 on the client device 106. In another example embodiment, the programmatic client 108 includes at least one of a content creation application, a collaborative application, and a shared storage application.

In one example embodiment, the pane personalization engine 126 communicates with the enterprise application 124 to identify suggestions that include content and content format based on the content provided by the user 132 in the programmatic client 108 (or in the web client 112, or enterprise application 124). The pane personalization engine 126 communicates with the pane notification module 110 supported by the web server 122 to provide the content and content format suggestion to the programmatic client 108. In one example, the web client 112 communicate with the pane personalization engine 126 and enterprise application 124 via the programmatic interface provided by the Application Program Interface (API) server 120. In another example embodiment, the pane personalization engine 126 sends the suggestion to the pane notification module 110. The pane notification module 110 determines whether to cause a display of the received suggestion in a pane pop-up based on current activities of the user 132 at the client device 106 and a user profile. In another example embodiment, the pane notification module 110 determines whether to cause a display of the received suggestion in the pane pop-up based on a profile of a cohort corresponding to a profile of the user 132.

In one example embodiment, the pane personalization engine 126 trains a machine learning model based on user application activities parameters. The pane personalization engine 126 uses the machine learning model to determine whether to generate and display a pane pop-up at the programmatic client 108 or the web client 112. In an alternative embodiment, for users who have not been interacting with the programmatic client 108 regularly (or who do not have a long history of engaging with the programmatic client 108), the system infers whether the user would like to use the suggestion feature by considering habits of similar cohorts.

The third-party application 116 may, for example, be another enterprise system (e.g., enterprise storage system). The application server 118 is shown to be communicatively coupled to database servers 128 that facilitates access to an information storage repository or databases 130. In an example embodiment, the databases 130 includes storage devices that store information to be published and/or processed by the enterprise application 124. In another example embodiment, the third-party application 116 accesses activities of the user 132 on the programmatic client 108. The third-party application 116 includes the pane personalization engine 126 and determines whether to trigger a content suggestion user interface element at the web client 112 or the programmatic client 108 based on a determination by the pane personalization engine 126.

Additionally, a third-party application 116 executing on a third-party server 114, is shown as having programmatic access to the application server 118 via the programmatic interface provided by the Application Program Interface (API) server 120. For example, the third-party application 116, using information retrieved from the application server 118, may supports one or more features or functions on a website hosted by the third party.

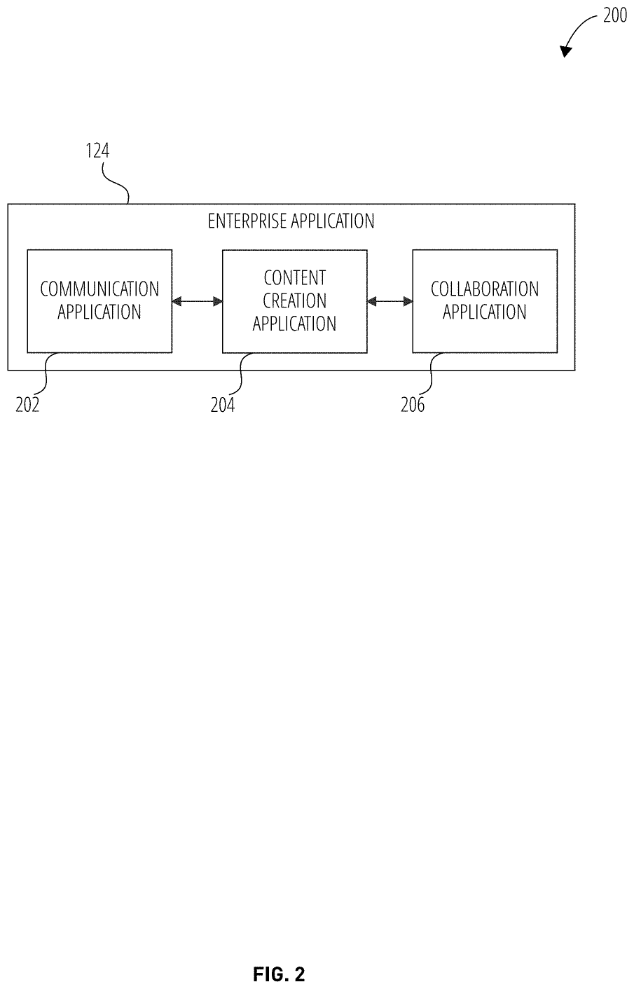

FIG. 2 illustrates an example of enterprise application 124 in accordance with one embodiment. The enterprise application 124 includes, for example, a communication application 202 (e.g., Microsoft Outlook™), a content creation application 204 (e.g., Microsoft Word™, Microsoft Power Point™, and a collaboration application 206 (e.g., Microsoft SharePoint™).

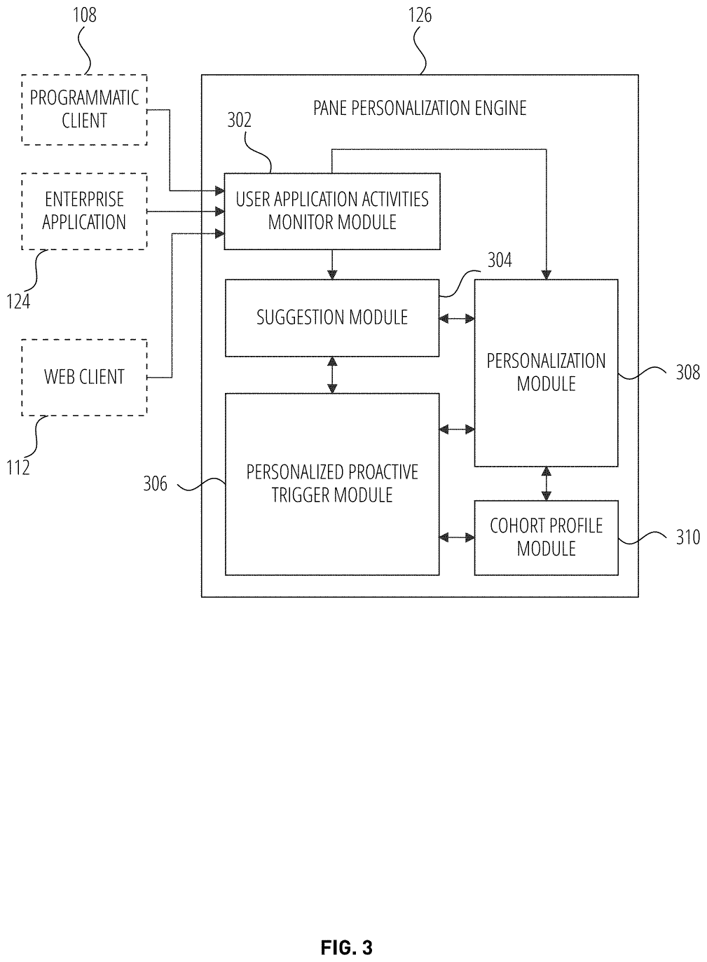

FIG. 3 is a block diagram illustrating a pane personalization engine 126 in accordance with one example embodiment. The user application activities monitor module 302 accesses user activities data from at least one of the programmatic client 108, the enterprise application 124, and the web client 112. In another example, the user application activities monitor module 302 combines user activities data from a combination of the programmatic client 108, the enterprise application 124, and the web client 112. In one example embodiment, the user activities data include user application activities within the programmatic client 108, the enterprise application 124, and the web client 112. For example, the user activities data include the type of content (e.g., a PowerPoint slide) being created by the user 132, which features of the enterprise application 124, programmatic client 108, and web client 112 are being used by the user 132, and other user activities related to the enterprise application 124, the programmatic client 108, and the web client 112.

Other examples of user activities data include: a frequency of whether the user has chosen the suggestion offered in the past; the kind of content already present in the user document; the quality of suggestion offered in the pane prompt (as determined by the user); the types of actions the user was taking prior to the pane prompt (to determine whether the user is deeply focused on operating the application—this also referred to as “focus mode”); and the user's frequency of engagement with the product (e.g., the application).

The user application activities monitor module 302 provides the user activities data to the suggestion module 304 and the personalization module 308. The suggestion module 304 determines a suggestion based on the user activities data and a content being provided by the user 132 in the web client 112 or the programmatic client 108. For example, the user 132 operates the programmatic client 108 to create a slide and provides text content describing a title for a team meeting: “how to increase productivity.” The user application activities monitor module 302 provides the text content to the suggestion module 304. The suggestion module 304 generates a suggestion based on the user activities data and the text content. For example, the suggestion includes an image of a chart showing an upward trend to match the “increase productivity” text content.

The personalization module 308 accesses the user activities data to generate a personalized suggestion trigger profile of the user 132. For example, experienced users may not wish to be displayed the suggestion every time they type in “increase productivity” in a content creation application. As such, the personalization module 308 monitors the activities of the user 132 to determine whether the user 132 is an experienced user and has previously indicated that suggestions are not needed by detecting that the user has repeatedly closed the pane that includes the suggestion. In another example, the personalization module 308 communicates with the suggestion module 304 and accesses the suggestion generated by the suggestion module 304.

In another example, the personalization module 308 determines that a context of the user activities based on the user activities data. For example, the personalization module 308 determines that the context of the user 132 indicates that the user 132 is deeply focused on operating the enterprise application and does not need interruptions. The personalization module 308 determines the context from signals provided by the enterprise application (e.g., user 132 enabled full screen mode of the enterprise application), and the operating system of client device 106 (e.g., user 132 has set the client device 106 or the programmatic client 108 to silence all notifications). In another example, the personalization module communicates with the suggestion module 304 and provides the context of the user activities.

In another example, the personalization module 308 determines that the user activities data do not exceed a minimum activity threshold. For example, the personalization module 308 determines that the user 132 may have not been interacting with the enterprise application 124 or programmatic client 108 regularly. In another example, the personalization module 308 determines that the number of user interaction with the enterprise application 124 is below a minimum threshold (e.g., the user 132 has opened and operated the enterprise application 124 two times within the last year). In the case where the user activities data does not exceed a minimum activity threshold, the personalization module 308 determines a cohort of the user based on a user profile of the user 132. For example, the personalization module 308 determines which cohort the user 132 belongs to. The personalization module 308 then retrieves a cohort profile corresponding to the cohort of the user 132 from a cohort profile module 310.

The personalization module 308 issues a request to the personalized proactive trigger module 306 to either trigger a display of the suggestion in a user interface element of the enterprise application 124 or programmatic client 108 based on a combination of the user activities data, the context of the user activities data, and the cohort profile corresponding to the user 132. In another example, the personalized proactive trigger module 306 prevents the suggestion module 304 from causing a display of the suggestion in a user interface element of the enterprise application 124 or programmatic client 108.

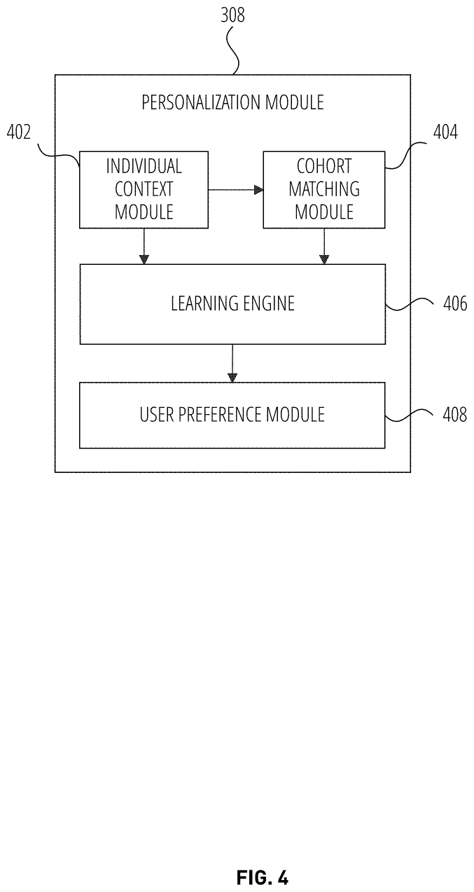

FIG. 4 is a block diagram illustrating a personalization module 308 in accordance with one embodiment. The personalization module 308 includes individual context module 402, a cohort matching module 404, a learning engine 406, and a user preference module 408.

The individual context module 402 determines that a context of the user activities based on the user activities data. For example, the individual context module 402 determines that the user 132 is deeply focused on operating the enterprise application and is avoiding interruptions. For example, the individual context module 402 detects that the user 132 has enabled a full screen feature mode of the enterprise application, and that the user 132 has set the client device 106 or the programmatic client 108 to silence all notifications.

In another example, the individual context module 402 determines a context of the user activities based on the following signals: a frequency of whether the user has chosen the suggestion offered in the past; the kind of content already present in the user document; the quality of suggestion offered in the pane prompt (as determined by the user); the types of actions the user was taking prior to the pane prompt (to determine whether the user is deeply focused on operating the application—this also referred to as “focus mode”); and the user's frequency of engagement with the product (e.g., the application).

The learning engine 406 trains a machine learning model based on the above signals to determine whether to cause a display of a suggestion pop up user interface element of in the enterprise application. In one example embodiments, the learning engine 406 analyzes events in the enterprise application 124 or programmatic client 108 to identify trends (e.g., a user has frequently chosen a suggestion in the past). The learning engine 406 accesses the above signals from the individual context module 402. Using the information from the signals, the learning engine 406 can identify trends. Based on the machine learning model, the learning engine 406 can, in one embodiment, suggest to the personalized proactive trigger module 306 whether to trigger and cause a display of the suggestion or prevent the suggestion from being displayed.

The cohort matching module 404 generates a user profile based on the following parameters: an enterprise segment of the user (e.g., major enterprise, small and medium enterprise, EDU, consumer); top collaborators the user has interacted with; groups to which the user belong; a manner in which the product is introduced to the user (e.g., first-time user, renewal); operating system and endpoint the user uses; and the time of the day the user uses the product.

The cohort matching module 404 identifies a cohort corresponding to the user 132 based on the user profile. In another example embodiment, the cohort matching module 404 identifies a cohort corresponding to the user 132 based on above parameters.

If the individual context module 402 determines that the user activities data do not exceed a minimum activity threshold. For example, the individual context module 402 determines that the user 132 may have not been interacting with the enterprise application 124 or programmatic client 108 regularly. In another example, the individual context module 402 determines that the number of user interaction with the enterprise application 124 is below a minimum threshold (e.g., the user 132 has opened and operated the enterprise application 124 two times within the last year). In the case where the user activities data do not exceed a minimum activity threshold, the individual context module 402 issues a request to the cohort matching module 404 to identify a user cohort corresponding to the user 132 based on a user profile of the user 132. In response to the request, the cohort matching module 404 determines to which cohort the user 132 belongs based on the above parameters. In another example embodiment, the cohort matching module 404 provides the corresponding user cohort profile to the learning engine 406.

The user preference module 408 generates a user preference based on the learning engine 406. For example, the user preference of the user 132 may indicate that the user 132 is an experienced user who does not wish to view suggestions only when operating the enterprise application in a “do not disturb” mode. The user preference is provided to the personalized proactive trigger module 306.

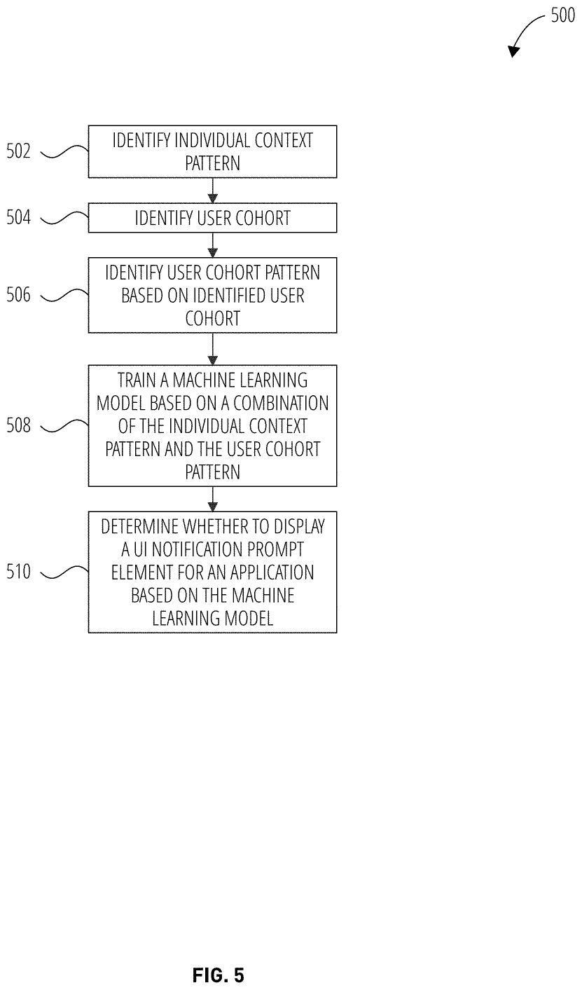

FIG. 5 is a flow diagram illustrating a method 500 for training a machine learning model in accordance with one example embodiment. Operations in the method 500 may be performed by the personalization module 308, using components (e.g., modules, engines) described above with respect to FIG. 4. Accordingly, the method 500 is described by way of example with reference to the personalization module 308. However, it shall be appreciated that at least some of the operations of the method 500 may be deployed on various other hardware configurations or be performed by similar components residing elsewhere. For example, some of the operations may be performed at the pane personalization engine 126.

At block 502, the individual context module 402 identifies individual context pattern based on the user application activities data accessed by the user application activities monitor module 302. At block 504, the cohort matching module 404 identifies a cohort corresponding to the user 132 based on the individual context pattern, the user profile, and the user application activities data. At block 506, the cohort matching module 404 identifies a user cohort pattern based on the identified user cohort. At block 508, the learning engine 406 trains a machine learning model based on a combination of the individual context pattern and the user cohort pattern. At block 510, the user preference module 408 generates a user preference that is used to determine whether to display a user interface notification prompt element for an application based on the machine learning model.

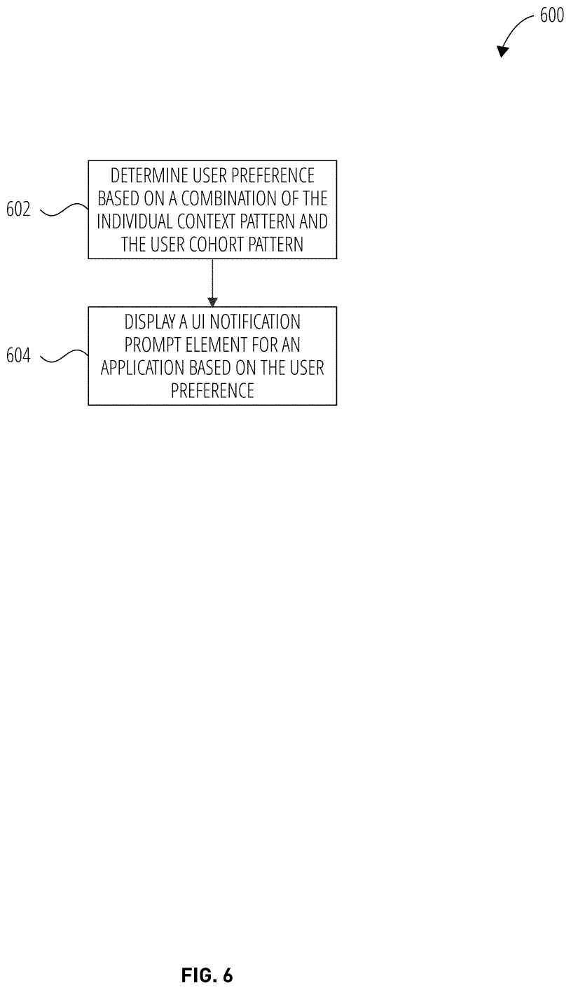

FIG. 6 is a flow diagram illustrating a method 600 for displaying a user interface notification element in accordance with one example embodiment. Operations in the method 600 may be performed by the personalization module 308, using components (e.g., modules, engines) described above with respect to FIG. 3. Accordingly, the method 600 is described by way of example with reference to the personalization module 308. However, it shall be appreciated that at least some of the operations of the method 600 may be deployed on various other hardware configurations or be performed by similar components residing elsewhere. For example, some of the operations may be performed at the pane personalization engine 126.

At block 602, the user preference module 408 determines a user preference based on a combination of the individual context pattern from the individual context module 402 and the identified cohort from the cohort matching module 404. At block 604, the user preference module 408 causes a request to display a user interface notification prompt element for an application based on the user preference. In one example embodiment, the user interface notification prompt element includes a pane pop-up of an enterprise application (e.g., programmatic client 108 or web-based enterprise application in the web client 112) being operated by the user of the client device 106. For example, the user 132 operates the enterprise application to select or generate content (e.g., a slide presentation). The enterprise application displays the pane pop-up. In another example embodiment, another application operating at the client device 106 provides or causes the pane pop-up to be displayed. In another example, the web client 112 displays the pane pop-up with the graphical user interface of the web client 112.

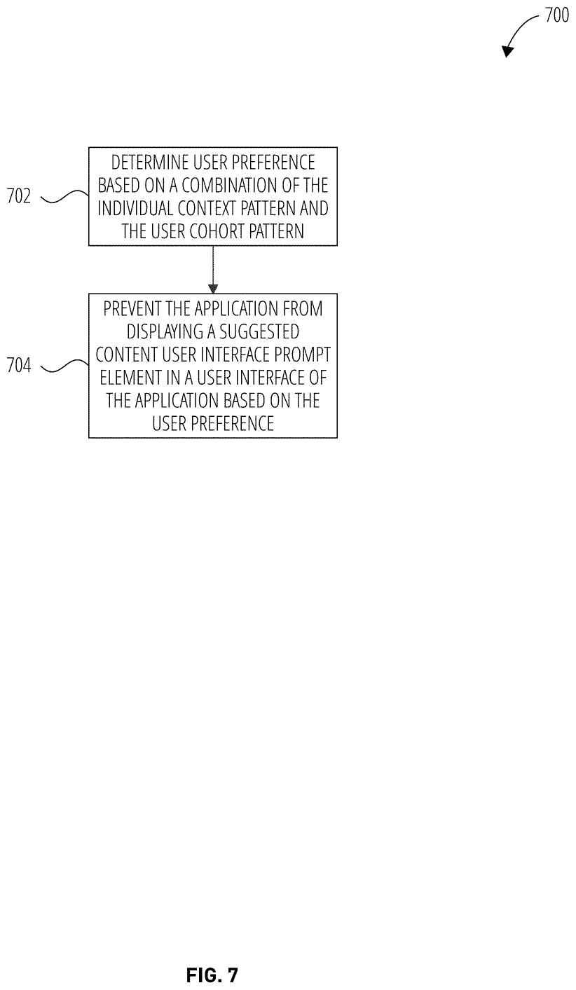

FIG. 7 is a flow diagram illustrating a method 700 for preventing the application from displaying a suggested content in accordance with one example embodiment. Operations in the method 700 may be performed by the personalization module 308, using components (e.g., modules, engines) described above with respect to FIG. 4. Accordingly, the method 700 is described by way of example with reference to the personalization module 308. However, it shall be appreciated that at least some of the operations of the method 700 may be deployed on various other hardware configurations or be performed by similar components residing elsewhere. For example, some of the operations may be performed at the suggestion module 304.

At block 702, the personalization module 308 determines a user enterprise application content suggestion preference based on a combination of the individual context pattern (as determined by the individual context module 402) and the user cohort pattern (as determined by the user cohort profile module 310 and the cohort matching module 404). At block 704, the personalization module 308 prevents or blocks the enterprise application from displaying a suggested content user interface prompt element in a user interface of the application based on the user enterprise application content suggestion preference. For example, the suggestion module 304 sends a request to the enterprise application 124 to display a suggested content based on the user application activities (as determined by the user application activities monitor module 302) to the personalized proactive trigger module 306. The personalization module 308 prevents or blocks the personalized proactive trigger module 306 from displaying the suggested content. For example, the personalization module 308 intercepts or detects the request from the suggestion module 304. The personalization module 308 evaluates whether the request should have been sent based on the user enterprise application content suggestion preference. If the personalization module 308 determines that the request from suggestion module 304 should have been sent, the personalization module 308 allows the suggestion to be displayed. If the personalization module 308 determines that the request from suggestion module 304 should not have been sent, the personalization module 308 blocks the suggestion from being displayed.

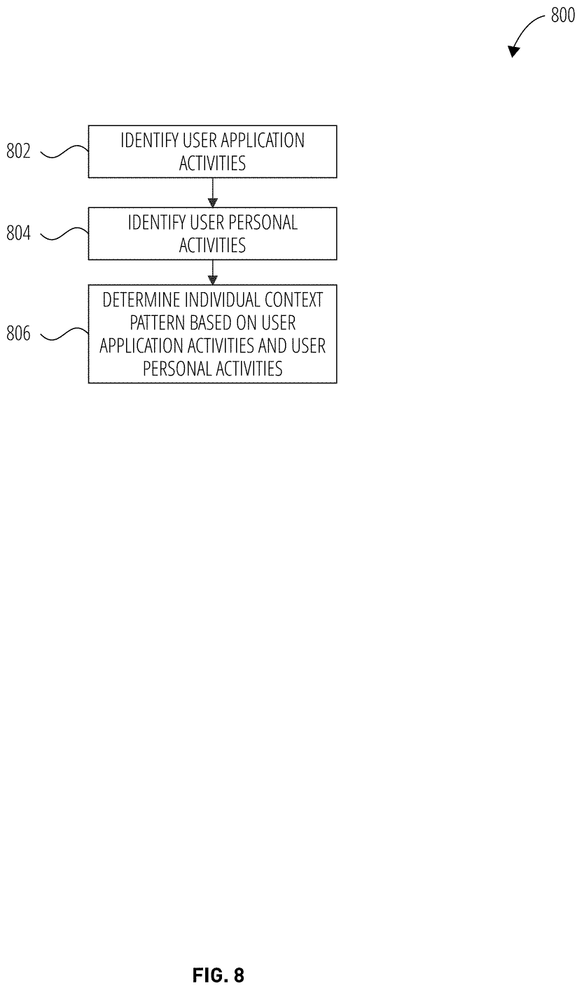

FIG. 8 is a flow diagram illustrating a method 800 for determining an individual context pattern in accordance with one example embodiment. Operations in the method 800 may be performed by the personalization module 308, using components (e.g., modules, engines) described above with respect to FIG. 3. Accordingly, the method 800 is described by way of example with reference to the personalization module 308. However, it shall be appreciated that at least some of the operations of the method 800 may be deployed on various other hardware configurations or be performed by similar components residing elsewhere. For example, some of the operations may be performed at the pane personalization engine 126.

At block 802, the user application activities monitor module 302 identifies user application activities. For example, the user application activities monitor module 302 determines which application features are being used, which buttons within the enterprise application are being clicked on, the type of document being edited with the enterprise application. At block 804, the individual context module 402 identifies personal activities of the user inside and outside the enterprise application. For example, the individual context module 402 determines that the user has minimized all other applications operating on the client device 106 except for the enterprise application. In another example, the individual context module 402 determines that the user has configured the operating system of the client device 106 to “do not disturb” mode or a “focused” mode. In another example, the individual context module 402 determines that the user has silenced notifications from the communication application 202.

At block 806, the individual context module 402 determines the individual context pattern based on the user application activities and the user personal activities. For example, the individual context module 402 determines that the user is an experience user of the enterprise application 124 by detecting that the user 132 has operated with the enterprise application 124 more than a predetermined minimum usage frequency threshold for the enterprise application 124. In another example, the individual context module 402 determines that the user 132 tends to operate the enterprise application 124 in focused mode on weekdays between 9 am and 11 am. For example, the individual context pattern includes, but is not limited to, whether the user is an experienced user, the times when the user operates in focus mode, the pattern of clicking on suggested content within the enterprise application 124.

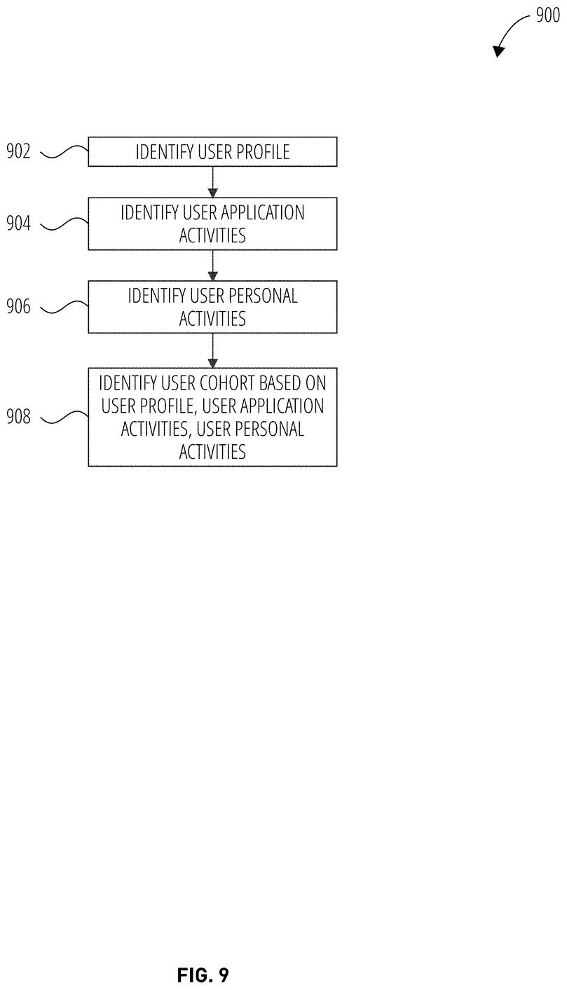

FIG. 9 is a flow diagram illustrating a method 900 for identifying a user cohort in accordance with one example embodiment. Operations in the method 900 may be performed by the pane personalization engine 126, using components (e.g., modules, engines) described above with respect to FIG. 3 and FIG. 4. Accordingly, the method 900 is described by way of example with reference to the pane personalization engine 126. However, it shall be appreciated that at least some of the operations of the method 900 may be deployed on various other hardware configurations or be performed by similar components residing elsewhere. For example, some of the operations may be performed at the pane personalization engine 126.

At block 902, the personalization module 308 identifies a user profile of the user 132 of the enterprise application 124. For example, the personalization module 308 detects that the user 132 is a new user of the enterprise application 124 and belongs to a particular enterprise group (e.g., marketing department).

At block 904, the user application activities monitor module 302 identifies user application activities (e.g., types of activities performed by the user 132 on the enterprise application 124). For example, the user application activities monitor module 302 determines that the user 132 has typed the words “bee” and “honey” in a content slide created by the enterprise application 124.

At block 906, the individual context module 402 identifies user personal activities. For example, the user application activities monitor module 302 determines that the user 132 has both the communication application 202 and the content creation application 204 opened on the client device 106. At block 908, the cohort matching module 404 identifies the user cohort based on the user profile, the user application activities, and the user personal activities.

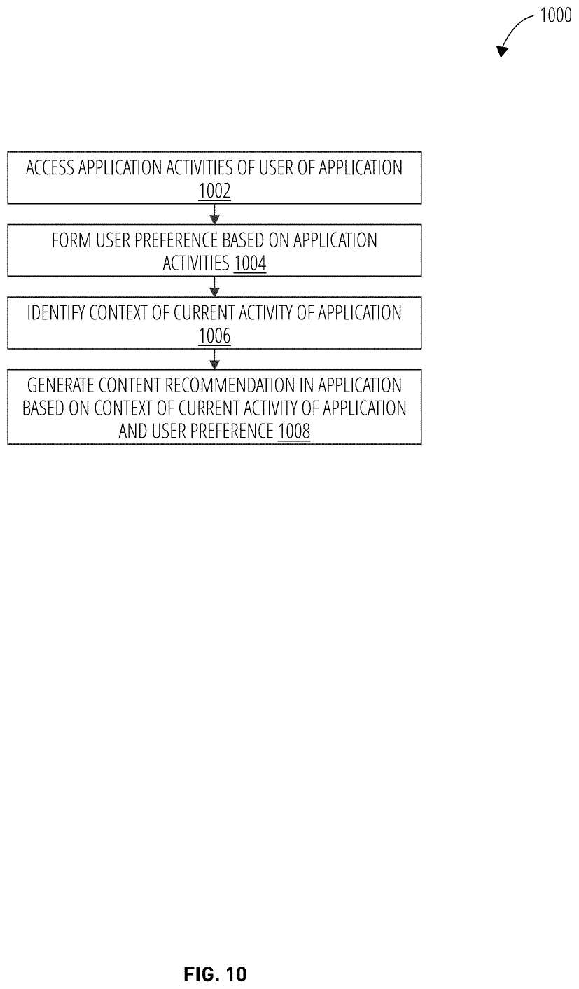

FIG. 10 is a flow diagram illustrating a routine in accordance with one embodiment. In block 1002, item 1000 accesses application activities of a user of an application. In block 1004, item 1000 forms a user preference based on the application activities. In block 1006, item 1000 identifies a context of a current activity of the application. In block 1008, item 1000 generates a content recommendation in the application based on the context of the current activity of the application and the user preference.

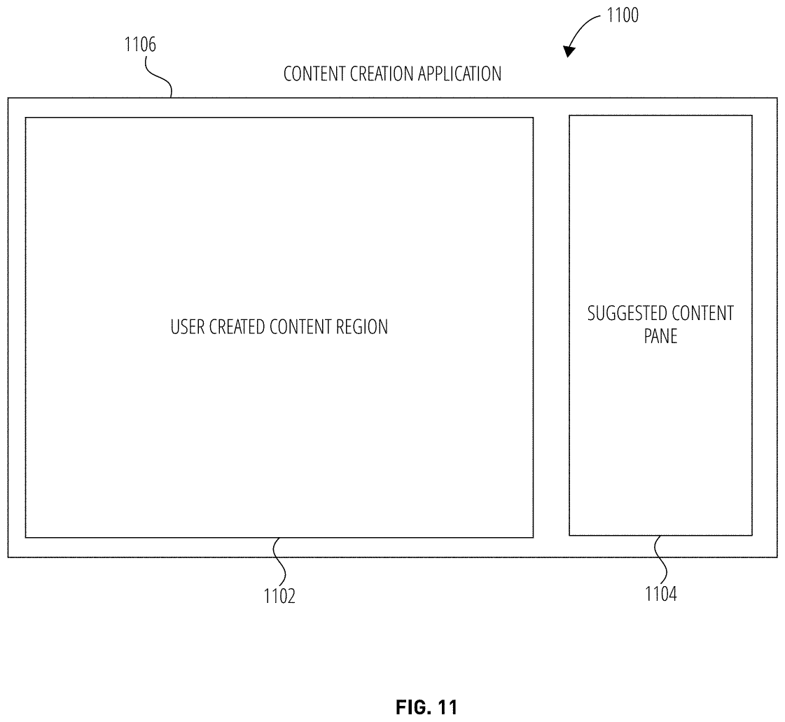

FIG. 11 illustrates an example of a graphical user interface 1100 in accordance with one example embodiment. The graphical user interface 1100 depicts the content creation application 1106, the user created content region 1102, the suggested content pane 1104. For example, the user 132 operates the content creation application 1106 by editing content in the user created content region 1102. The personalized proactive trigger module 306 causes a display of the suggested content pane 1104 based on the content in the user created content region 1102. The suggested content pane 1104 includes a pop-up element that is triggered by the content in the user created content region 1102. The user 132 can then select a suggested content displayed in the suggested content pane 1104 and then close the suggested content pane 1104.

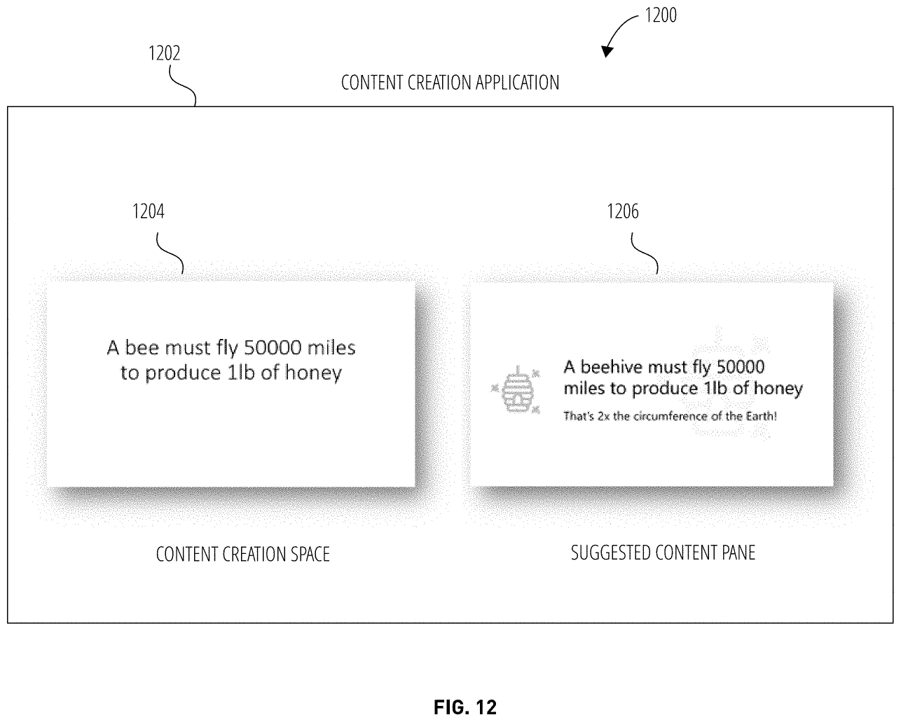

FIG. 12 illustrates an example of a graphical user interface 1200 in accordance with one example embodiment. The graphical user interface 1200 depicts the content creation application 1202, the content creation space 1204, and the content creation pane 1206. The content creation space 1204 includes content provided or edited by the user 132. The content creation pane 1206 includes suggested content.

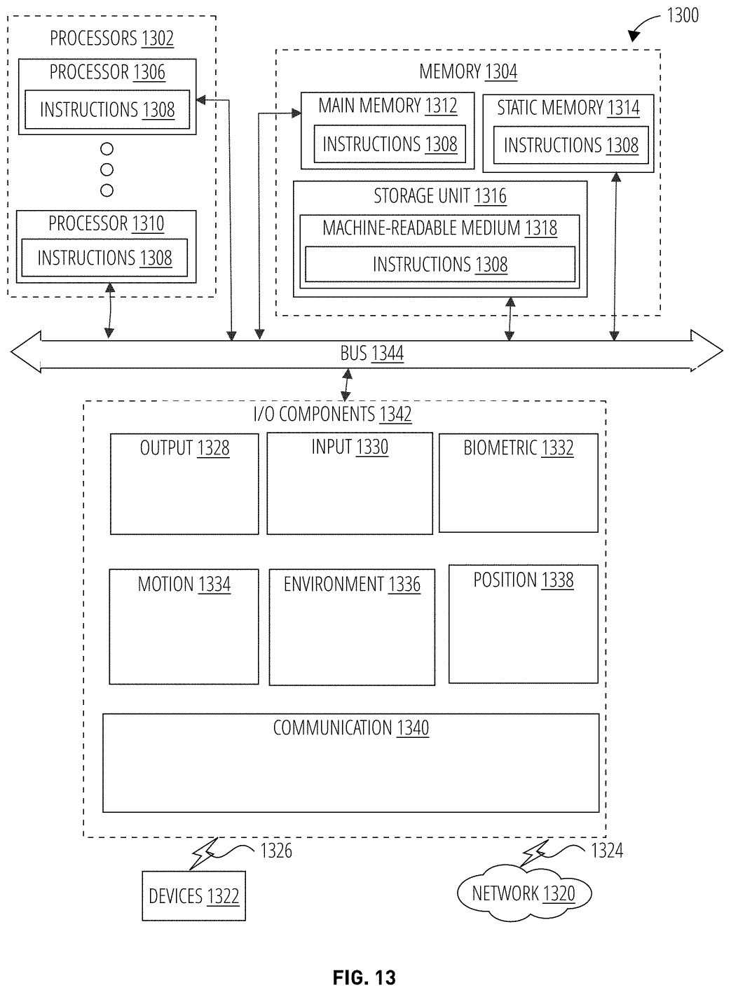

FIG. 13 is a diagrammatic representation of the machine 1300 within which instructions 1308 (e.g., software, a program, an application, an applet, an app, or other executable code) for causing the machine 1300 to perform any one or more of the methodologies discussed herein may be executed. For example, the instructions 1308 may cause the machine 1300 to execute any one or more of the methods described herein. The instructions 1308 transform the general, non-programmed machine 1300 into a particular machine 1300 programmed to carry out the described and illustrated functions in the manner described. The machine 1300 may operate as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1308, sequentially or otherwise, that specify actions to be taken by the machine 1300. Further, while only a single machine 1300 is illustrated, the term “machine” shall also be taken to include a collection of machines that individually or jointly execute the instructions 1308 to perform any one or more of the methodologies discussed herein.

The machine 1300 may include processors 1302, memory 1304, and I/O components 1342, which may be configured to communicate with each other via a bus 1344. In an example embodiment, the processors 1302 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1306 and a processor 1310 that execute the instructions 1308. The term “processor” is intended to include multi-core processors that may comprise two or more independent processors (sometimes referred to as “cores”) that may execute instructions contemporaneously. Although FIG. 13 shows multiple processors 1302, the machine 1300 may include a single processor with a single core, a single processor with multiple cores (e.g., a multi-core processor), multiple processors with a single core, multiple processors with multiples cores, or any combination thereof.

The memory 1304 includes a main memory 1312, a static memory 1314, and a storage unit 1316, both accessible to the processors 1302 via the bus 1344. The main memory 1304, the static memory 1314, and storage unit 1316 store the instructions 1308 embodying any one or more of the methodologies or functions described herein. The instructions 1308 may also reside, completely or partially, within the main memory 1312, within the static memory 1314, within machine-readable medium 1318 within the storage unit 1316, within at least one of the processors 1302 (e.g., within the processor's cache memory), or any suitable combination thereof, during execution thereof by the machine 1300.

The I/O components 1342 may include a wide variety of components to receive input, provide output, produce output, transmit information, exchange information, capture measurements, and so on. The specific I/O components 1342 that are included in a particular machine will depend on the type of machine. For example, portable machines such as mobile phones may include a touch input device or other such input mechanisms, while a headless server machine will likely not include such a touch input device. It will be appreciated that the I/O components 1342 may include many other components that are not shown in FIG. 13. In various example embodiments, the I/O components 1342 may include output components 1328 and input components 1330. The output components 1328 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1330 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1342 may include biometric components 1332, motion components 1334, environmental components 1336, or position components 1338, among a wide array of other components. For example, the biometric components 1332 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1334 include acceleration sensor components (e.g., accelerometer), gravitation sensor components, rotation sensor components (e.g., gyroscope), and so forth. The environmental components 1336 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1338 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1342 further include communication components 1340 operable to couple the machine 1300 to a network 1320 or devices 1322 via a coupling 1324 and a coupling 1326, respectively. For example, the communication components 1340 may include a network interface component or another suitable device to interface with the network 1320. In further examples, the communication components 1340 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 1322 may be another machine or any of a wide variety of peripheral devices (e.g., a peripheral device coupled via a USB).

Moreover, the communication components 1340 may detect identifiers or include components operable to detect identifiers. For example, the communication components 1340 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1340, such as location via Internet Protocol (IP) geolocation, location via Wi-Fi® signal triangulation, location via detecting an NFC beacon signal that may indicate a particular location, and so forth.

The various memories (e.g., memory 1304, main memory 1312, static memory 1314, and/or memory of the processors 1302) and/or storage unit 1316 may store one or more sets of instructions and data structures (e.g., software) embodying or used by any one or more of the methodologies or functions described herein. These instructions (e.g., the instructions 1308), when executed by processors 1302, cause various operations to implement the disclosed embodiments.

The instructions 1308 may be transmitted or received over the network 1320, using a transmission medium, via a network interface device (e.g., a network interface component included in the communication components 1340) and using any one of a number of well-known transfer protocols (e.g., hypertext transfer protocol (HTTP)). Similarly, the instructions 1308 may be transmitted or received using a transmission medium via the coupling 1326 (e.g., a peer-to-peer coupling) to the devices 1322.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

### EXAMPLES

Example 1 is a computer-implemented method comprising: accessing application activities of a user of an application; forming a user preference based on the application activities; identifying a context of a current activity of the application; and generating a content recommendation in the application based on the context of the current activity of the application and the user preference.

Example 2 is the method of example 1, wherein forming the user preference further comprises: identifying a pattern of the application activities of the user; identifying a user profile of the user; training a machine learning model based on the user profile and the pattern of the application activities of the user; and generating the user preference based on the machine learning model.

Example 3 is the method of example 1, wherein forming the user preference further comprises: identifying a cohort of the user based on a user profile of the user; identifying a cohort application preference corresponding to the cohort of the user; and generating the content recommendation based on the context of the current activity of the application and the cohort application preference.

Example 4 is the method of example 3, wherein the application activities comprise: a number of times the user has selected a previous content recommendation displayed in a second user interface element of the application, a frequency of user engagement with the application, user content being present in a first user interface element of the application, user activities prior to a display of the content recommendation in the second user interface element of the application, and wherein the cohort of the user is determined based on: an enterprise profile of the user, collaborators of the user, a group within the enterprise to which the user belongs, an operating system of the client device, and a time and day of the application activities of the user.

Example 5 is the method of example 1, further comprising: determining that a number of application activities of the user is below a minimum activity threshold for the application; in response to determining that the number of application activities of the user is below the minimum activity threshold for the application, identifying a cohort of the user based on a user profile of the user; identifying a cohort application preference corresponding to the cohort of the user; generating the content recommendation based on the context of the current activity of the application and the cohort application preference; and causing a display of the content recommendation in a user interface element of the application based on the cohort application preference.

Example 6 is the method of example 1, further comprising: causing a display of a first user interface element adjacent to a second user interface element in response to generating the content recommendation, the first user interface element comprising a first content selected by the user of the application, the second user interface element comprising a second content from the content recommendation.

Example 7 is the method of example 6, wherein a first display format of the first content is selected by the user of the application, wherein a second display format of the second content is provided by the content recommendation.

Example 8 is the method of example 7, wherein the second display format comprises a modification of the first display format, the first display format comprising a first graphical format of the first content, the second display format comprising a second graphical format based on the first content.

Example 9 is the method of example 1, further comprising: determining that the context of the current activity of the application indicates that the user is focused on providing content in the application based on a type of activities of the user in the application; and preventing the application from displaying the content recommendation in the user interface element of the application based on the user being focus on providing content in the application.

Example 10 is the method of example 1, wherein the application comprises at least one of an enterprise content creation application, an enterprise collaboration application, and an enterprise communication application.

What is claimed is:

1. A computer-implemented method comprising:
accessing application activities of a user of an application;
forming a user preference based on the application activities;
identifying a context of a current activity of the application; and
generating a content recommendation in the application based on the context of the current activity of the application and the user preference.

2. The computer-implemented method of claim 1, wherein forming the user preference further comprises:
identifying a pattern of the application activities of the user;
identifying a user profile of the user;
training a machine learning model based on the user profile and the pattern of the application activities of the user; and
generating the user preference based on the machine learning model.

3. The computer-implemented method of claim 1, wherein forming the user preference further comprises:
identifying a cohort of the user based on a user profile of the user;
identifying a cohort application preference corresponding to the cohort of the user; and
generating the content recommendation based on the context of the current activity of the application and the cohort application preference.

4. The computer-implemented method of claim 3, wherein the application activities comprise: a number of times the user has selected a previous content recommendation displayed in a second user interface element of the application, a frequency of user engagement with the application, user content being present in a first user interface element of the application, user activities prior to a display of the content recommendation in the second user interface element of the application, and
wherein the cohort of the user is determined based on: an enterprise profile of the user, collaborators of the user, a group within the enterprise to which the user belongs, an operating system of the client device, and a time and day of the application activities of the user.

5. The computer-implemented method of claim 1, further comprising:
determining that a number of application activities of the user is below a minimum activity threshold for the application;
in response to determining that the number of application activities of the user is below the minimum activity threshold for the application, identifying a cohort of the user based on a user profile of the user;
identifying a cohort application preference corresponding to the cohort of the user;
generating the content recommendation based on the context of the current activity of the application and the cohort application preference; and
causing a display of the content recommendation in a user interface element of the application based on the cohort application preference.

6. The computer-implemented method of claim 1, further comprising:
causing a display of a first user interface element adjacent to a second user interface element in response to generating the content recommendation, the first user interface element comprising a first content selected by the user of the application, the second user interface element comprising a second content from the content recommendation.

7. The computer-implemented method of claim 6, wherein a first display format of the first content is selected by the user of the application, wherein a second display format of the second content is provided by the content recommendation.

8. The computer-implemented method of claim 7, wherein the second display format comprises a modification of the first display format, the first display format comprising a first graphical format of the first content, the second display format comprising a second graphical format based on the first content.

9. The computer-implemented method of claim 1, further comprising:
determining that the context of the current activity of the application indicates that the user is focused on providing content in the application based on a type of activities of the user in the application; and
preventing the application from displaying the content recommendation in the user interface element of the application based on the user being focus on providing content in the application.

10. The computer-implemented method of claim 1, wherein the application comprises at least one of an enterprise content creation application, an enterprise collaboration application, and an enterprise communication application.

11. A computing apparatus, the computing apparatus comprising:
a processor; and
a memory storing instructions that, when executed by the processor, configure the apparatus to:
access application activities of a user of an application;
form a user preference based on the application activities;
identify a context of a current activity of the application; and
generate a content recommendation in the application based on the context of the current activity of the application and the user preference.

12. The computing apparatus of claim 11, wherein forming the user preference further comprises:
identify a pattern of the application activities of the user;
identify a user profile of the user;
train a machine learning model based on the user profile and the pattern of the application activities of the user; and
generate the user preference based on the machine learning model.

13. The computing apparatus of claim 11, wherein forming the user preference further comprises:
identify a cohort of the user based on a user profile of the user;
identify a cohort application preference corresponding to the cohort of the user; and
generate the content recommendation based on the context of the current activity of the application and the cohort application preference.

14. The computing apparatus of claim 13, wherein the application activities comprise: a number of times the user has selected a previous content recommendation displayed in a second user interface element of the application, a frequency of user engagement with the application, user content being present in a first user interface element of the application, user activities prior to a display of the content recommendation in the second user interface element of the application, and
wherein the cohort of the user is determined based on: an enterprise profile of the user, collaborators of the user, a group within the enterprise to which the user belongs, an operating system of the client device, and a time and day of the application activities of the user.

15. The computing apparatus of claim 11, wherein the instructions further configure the apparatus to:
determine that a number of application activities of the user is below a minimum activity threshold for the application;
in response to determining that the number of application activities of the user is below the minimum activity threshold for the application, identify a cohort of the user based on a user profile of the user;
identify a cohort application preference corresponding to the cohort of the user;
generate the content recommendation based on the context of the current activity of the application and the cohort application preference; and
cause a display of the content recommendation in a user interface element of the application based on the cohort application preference.

16. The computing apparatus of claim 11, wherein the instructions further configure the apparatus to:
cause a display of a first user interface element adjacent to a second user interface element in response to generating the content recommendation, the first user interface element comprising a first content selected by the user of the application, the second user interface element comprising a second content from the content recommendation.

17. The computing apparatus of claim 16, wherein a first display format of the first content is selected by the user of the application, wherein a second display format of the second content is provided by the content recommendation.

18. The computing apparatus of claim 17, wherein the second display format comprises a modification of the first display format, the first display format comprising a first graphical format of the first content, the second display format comprising a second graphical format based on the first content, wherein the application comprises at least one of an enterprise content creation application, an enterprise collaboration application, and an enterprise communication application.

19. The computing apparatus of claim 11, wherein the instructions further configure the apparatus to:
determine that the context of the current activity of the application indicates that the user is focused on providing content in the application based on a type of activities of the user in the application; and
prevent the application from displaying the content recommendation in the user interface element of the application based on the user being focus on providing content in the application.

20. A non-transitory computer-readable storage medium, the computer-readable storage medium including instructions that when executed by a computer, cause the computer to:
access application activities of a user of an application;
form a user preference based on the application activities;
identify a context of a current activity of the application; and
generate a content recommendation in the application based on the context of the current activity of the application and the user preference.
